(19) United States
(12) Patent Application Publication
(10) Pub. No.: US 2017/0230290 A1
(43) Pub. Date: Aug. 10, 2017

(54) MULTI-DOMAIN CENTRALIZED CONTENT-CENTRIC NETWORKING

(71) Applicant: PEKING UNIVERSITY SHENZHEN GRADUATE SCHOOL, Shenzhen (CN)

(72) Inventors: Hui LI, Shenzhen (CN); Jun LU, Shenzhen (CN); Wensheng CHEN, Shenzhen (CN); Fuxing CHEN, Shenzhen (CN)

(21) Appl. No.: 15/442,626

(22) Filed: Feb. 25, 2017

Related U.S. Application Data
(63) Continuation of application No. PCT/CN2015/096859, filed on Dec. 9, 2015.

(51) Int. Cl. H04L 12/743; H04L 12/747; H04L 12/751; H04L 12/721; H04L 12/24; H04L 12/715

(52) U.S. Cl. CPC H04L 45/7457; H04L 41/12; H04L 45/04; H04L 45/02; H04L 45/26; H04L 45/742

(57) ABSTRACT

A multi-domain centralized content-centric networking (MCCN), including: a management layer; a control layer; and a data layer. The management layer communicates with the data layer through the control layer. The management layer is configured to acquire application transmission requests, network resource allocation, and network running status, and give network operating commands to a control plane according to reconfiguration of management strategies. The control layer is configured to carry out routing establishment, maintain network topology of domains, inform the management layer of network status, and execute commands of the management layer. The data layer is configured to process data packet according to commands of the control layer. The task of the data layer is completed by a router and link of the bottom layer.

### CROSS-REFERENCE TO RELATED APPLICATIONS

This application is a continuation of International patent application Ser. No. PCT/CN2015/096859 with an international filing date of Dec. 9, 2015, designating the United States, now pending, the contents of which and any intervening amendments thereto are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

Field of the Invention

The invention relates to the network protocol field, and more particularly to a multi-domain centralized content-centric networking (MCCN).

Description of the Related Art

To meet constantly increasing information access requirements, some Internet data distribution techniques such as P2P (peer-to-peer), Pub/Sub (publication/subscription), CDN (content delivery network) and Web Cache have been developed in succession. Although these techniques center on information, there are a lot of redundant data transmission at the application layer and the utilization rate of network resources is not high.

Information centric networking (ICN) adopts the information-centric network communication model to replace the traditional address-centric network communication model. The communication model evolves from the host-to-host model to the host-to-network model. The transmission model has changed from “pushing” to “pulling”. The security mechanism is built on information rather than on hosts. The forward mechanism evolves from store-and-forward into cache-and-forward. The architecture supports host movements and has solved the problem of high-efficient transmission of mass information.

Content-centric networking (CCN) refers to networking centering on content and is different from the current internet centering on hosts. CCN marks every piece of content through content names. For networking, the flowing content is all content with names. Networking distinguishes every piece of content and its function is to manage the flow of all content and respond to content requesters with correct content. CCN decouples content senders and receivers in time and space by using internal cache of network equipment and can better adapt to today's network characteristics (like content distribution and movement). CCN has two kinds of packets: Interest and Data packets. When content consumers need to request content, the Interest packet is broadcasted and each route node searches for and returns back to the corresponding Data packet of the “name” according to the Interest packet name and the longest prefix. On the route node, three key data structures complete packet forwarding, which are Content Store, Pending Interest Table (PIT) and FIB.

When an Interest packet arrives, CCN matches with entries of Content Store (CS) firstly. If there is a matched entry, CCN responds and sends a Data packet and abandons the Interest packet. CCN matches with entries of PIT secondly. If there is a matched entry, CCN adds Face to the responded entry of PIT and abandons the Interest packet. Finally, CCN matches with entries of FIB, forwards the Interest packet according to all the matched Face and stores the Interest packet in the record of PIT. If there is not any matched entry of FIB, CCN abandons the Interest packet. As for the processing of the Data packet, it is relatively simple. When the Data packet arrives, CCN matches with the longest prefix of the Content Name field of the Data packet. CCN matches with entries of Content Store firstly (If there is a matched entry, CCN abandons the Data packet.). Then CCN matches with entries of PIT. If there is a matched entry, CCN forwards it to the requester and then records it in CS through cache. If there is not any matched entry, CCN abandons the Data packet.

The centralized network control and management mode is to set up special network control and management nodes in the network system. Management software and control functions mainly focus on the network management control nodes. The nodes under management and control are subordinate to the network management and control nodes. Generally, the centralized network is a network of star or tree topology. The concepts of centralization and distribution are often used for resource management. When a lot of resources gather in one place, this is a centralized mode. When resources scatter in different places, this is a distributed mode. The centralized and distributed types have their own advantages and disadvantages.

The strict centralized control plane is characterized by the unified configuration platform, single point of failure and difficult horizontal expansion. The semi-centralized or logic centralized control plane is characterized in that the unified configuration plane needs to synchronize with other backstage control plane embodiments but needs to take a period of time; can restore multi-points of failure but is easy to be influenced by the synchronization status with other control planes; and is easy to expand horizontally but only needs to arrange new embodiments of the control plane. The completely distributed control plane is characterized in that: all (logic or real) equipment has a control plane embodiment; it has proven high restoration of failure; it may be difficult to restrain; and it is difficult to expand horizontally and new equipment needs to be added during horizontal expansion.

The transformation from distribution to centralization means that the centralized control plane must solve the shortcomings while giving play to the advantages of the centralized control plane. As for the centralized control plane, the centralization of control plane can certainly facilitate the management and configuration of the whole network by network administrators, arrange network resources in a reasonable way, further improve the network and improve the effective network utilization rate. Meanwhile, the centralized control plane can realize the programmable network better by taking advantage of centralized resources.

As for a centralized network, every control and management node and the router under its control and management constitute a control and management domain. The communication between control and management domains is called cross-domain. The cross-domain of centralized network is for massive arrangements to lower the burden of control and management nodes.

The SCN (Service Carrier network) is a dedicated network built on the reconfigurable basic information communication network according to the capacity of providing network services, users' requirements and business characteristics. As shown in FIG. 1, the SCN is geared to special characteristics of a kind of business, can realize dynamic regulation and expansion and contraction, and has highly flexible service capacity.

CCNx does not develop routing protocols by itself. University of Memphis, Arizona State University and UCLA (University of California, Los Angeles) have developed a routing protocol jointly for CCNx. The routing protocol is named NLSR (Named-data Link State Routing Protocol). The OSPFN is an OSPF protocol similar to IP communication in the content network. The NLSR (Named-data Link State Routing Protocol) has four main design characteristics: the layered naming mode like “/network/router/resource” which is a three-layer naming mode; the reliable model for intra-domain management; the hop-by-hop routing status synchronization protocol; and the simplified multi-path choice. In the NLSR (Named-data Link State Routing Protocol), CCN routers inform direct routers of neighbors and content name prefixes in the network. Neighbors collect link information and establish topology and calculate routing tables according to the topology. Then, the collected content name prefixes are added to the FIB according to the routing tables. Every FIB table entrance contains a content name prefix and one or a plurality of corresponding next-hop routers. Therefore, every router has all intra-domain content name prefixes and can be routed to all intra-domain content.

Named-data Link State Routing Protocol (NLSR) as an autonomous intra-domain routing protocol of CCNx adopts the distributed routing computation to calculate the autonomous and routing of the whole network at every routing node and saves the content name prefixes of the whole network.

The shortcomings of the NLSR are as follows:

The amount of content name prefixes is much larger than the amount of IP addresses and keeps expanding at a high speed. Every NLSR (Named-data Link State Routing Protocol) router tries to establish a FIB table covering the whole network. The order of the FIB table can reach 109. This needs a large quantity of storage resources which even cannot be solved actually.

Every router which supports every NLSR (Named-data Link State Routing Protocol) needs to complete the LSDB (Link State Database) synchronization, network topology discovery and routing computation functions. With the expansion of the FIB table, the LSDB synchronization of every router occupies too much bandwidth and routing computation costs too many computing resources.

Actually, network topology is unique at a certain moment. Every router independently realizes network topology discovery and routing computation, which causes certain computing redundancy.

In addition, the SDN (Software Defined Network) is a new-type network innovation architecture of Emulex network and an implementation model of network virtualization. Its core technique OpenFlow realizes flexible control of network flow and makes the network as pipelines smarter by separating the control plane of network equipment from its data plane.

The overall architecture of SDN (Software Defined Network) as shown in FIG. 2 is divided into the forwarding plane and the control plane. The forwarding plane is constituted by universal network forwarding equipment, receives commands from the control plane and executes the forwarding of messages and network layer operation. The control plane is a SDN controller and realizes centralized management and control of equipment of the forwarding plane by the southbound interface. Meanwhile, the SDN (Software Defined Network) controller can even define the network flexibly, realize network abstraction and virtualization, provide the network capacity calling interface for upper-layer applications through the northbound interface and realize the openness of network capacity.

Although the SDN provides the idea of separating forwarding from control, the SDN is based on the IP communication network and cannot be used for the centralized content network. The typical application scenario of the SDN is a data center. Every data center is an independent control and management domain and is similar to the autonomous domain in the IP network. The control and management domains are independent from each other, that is, the original SDN does not take cross-domain behaviors into account well.

### SUMMARY OF THE INVENTION

In view of the above-described problems, it is one objective of the invention to provide a multi-domain centralized content-centric networking (MCCN) to solve the problems that conventional networking cannot expand and is not easy to control.

To achieve the above objective, in accordance with one embodiment of the invention, there is provided a multi-domain centralized content-centric networking (MCCN) which comprises a management layer, a control layer and a data layer. The management layer communicates with the data layer through the control layer. The management layer is configured to acquire application transmission requests, network resource allocation and network running status and give network operating commands to the control plane according to reconfiguration of management strategies. The control layer carries out routing establishment, maintains the network topology of domains, informs the management layer of the network status, and executes the commands of the management layer. The data layer is configured to process the data packet according to the commands of the control layer. The task of the data layer is completed by the router and link of the bottom layer.

In a class of this embodiment, a working principle of the control layer is as follows: the Master is linked to the Controller of each domain directly through switch equipment; in the Master, every control and management domain is abstracted as a node and the Controller of each control and management domain sends the domain link information periodically to the Master; according to the domain information uploaded by each control server, the Master builds topological structures of all control and management domains so as to carry out the coarse-grained control of each domain; the control server of each control and management domain controls the node and link of the corresponding domain so as to carry out the fine-grained control of the domain; and the Controller collects the uploaded neighbor information and link information from routing nodes and builds an intra-domain topological graph to work out paths for intra-domain routing.

In a class of this embodiment, every service carrier network of routers comprises a PIT and a FIB table in the router. The Interest packet records and forwards data, according to the PIT and FIB of the service carrier network of the Interest packet.

In a class of this embodiment, the intra-domain communication of the multi-domain centralized content-centric networking (MCCN) comprises content registration, topological management and routing computation.

In a class of this embodiment, the specific content of the content registration is that: when content is sent to a router, the router verifies the content Data packet and if the Data packet is reliable, the Data packet is added to the content store and registration information is sent to the domain controller of the router; and the specific content of the topological management is that: all routers are linked to intra-domain controllers through switches, the communication between the intra-controllers and the routers adopts the signaling channel different from the Data packet communication, the router transmits heartbeat information to the controller in a unidirectional way and the intra-domain controller constantly updates the heartbeat information of the router; and the routing computation is that: the controller works out the best path to release the entries of the routing table according to the reconfigurable carrier network.

In a class of this embodiment, when carrying out the inter-domain communication, the multi-domain centralized content-centric networking (MCCN) sends the Interest packet to link routing paths through border routers; inter-domain paths are linked by a plurality of intra-domain paths; and the intra-domain controller just completes the task of the corresponding domain.

In a class of this embodiment, controllers release paths.

In a class of this embodiment, routers decide whether the content of the received Data packet is the new content released by a content publisher for router cache and registration so that controllers can perform addressing or is the existing content forwarding between routers.

The advantageous effects of multi-domain centralized content-centric networking (MCCN) of the invention are as follows: the MCCN divides service carrier networks according to business requirements and can take advantage of bottom-layer resources better; and controllers release paths, which avoids transmission of enormous Internet packets caused by flooding and effectively improves the utilization rate of links.

### BRIEF DESCRIPTION OF THE DRAWINGS

FIG. 1 is a schematic diagram of an existing SCN (Service Carrier networking) service carrier network;

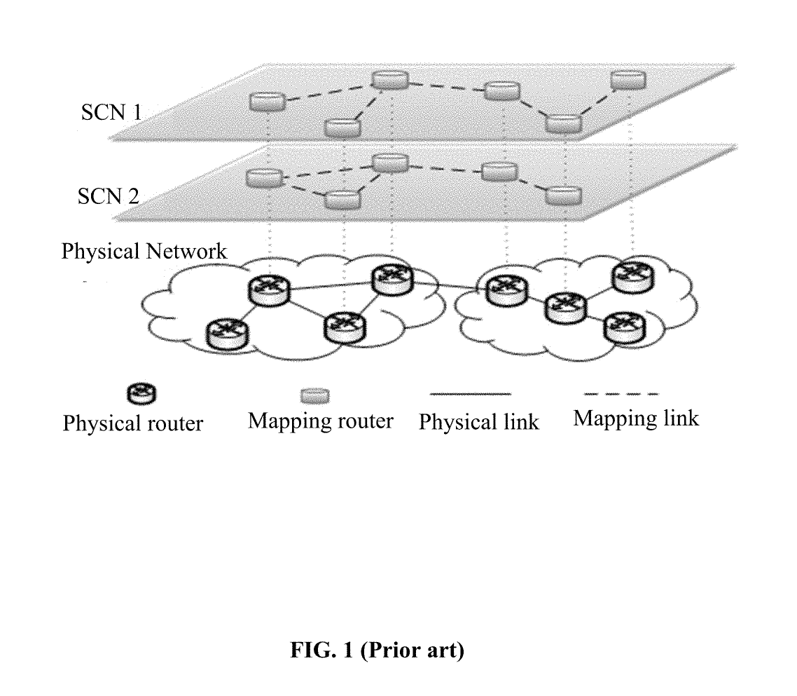

FIG. 2 is an overall architecture diagram of the existing SDN (Software Defined Network);

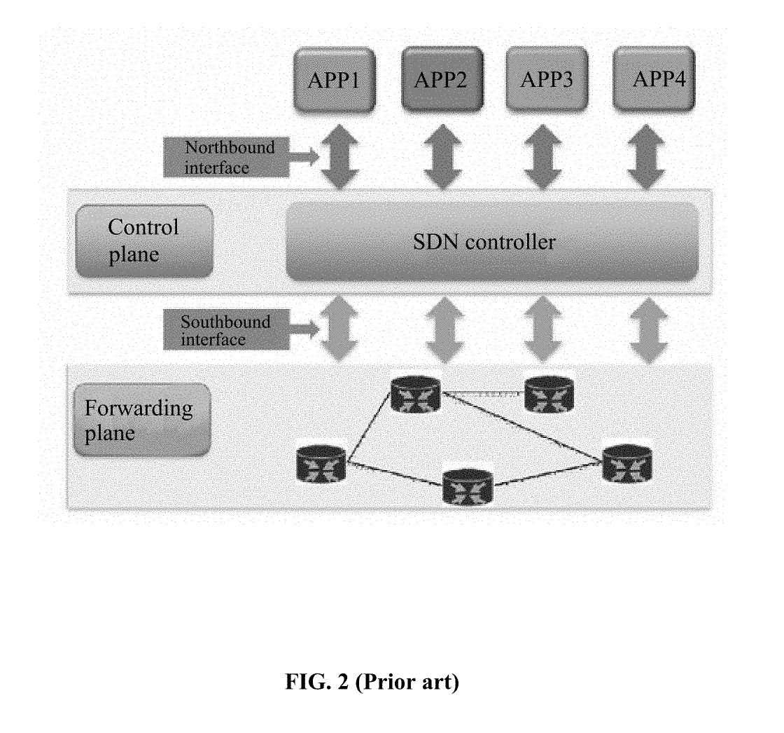

FIG. 3 is a structural diagram of MCCN in accordance with one embodiment of the invention;

FIG. 4 is a data packet format MCCN in accordance with one embodiment of the invention;

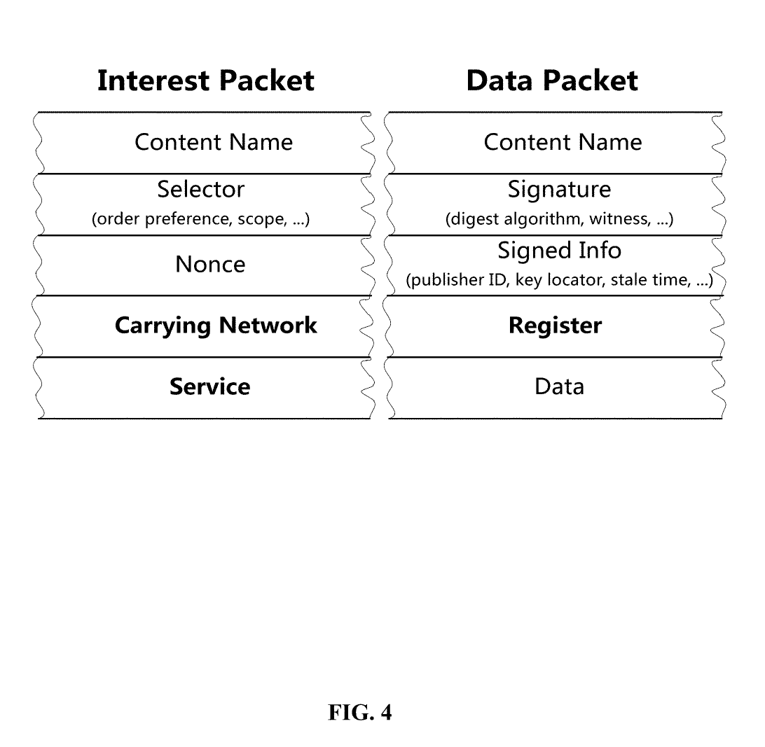

FIG. 5 is an intra-domain communication procedure chart of MCCN in accordance with one embodiment of the invention; and

FIG. 6 is an inter-domain communication diagram of MCCN in accordance with one embodiment of the invention.

### DETAILED DESCRIPTION OF THE EMBODIMENT

The invention is further explained by the description of the figures and embodiments as follows.

Acronyms and Definitions of Key Terms

ICN: Information centric networking

SDN: Software Defined Network

CCN: Content Centric Networking

NLSR: Named-data Link State Routing Protocol

FIB: Forwarding Information Base

CS: Content Store

PIT: Pending Information Table

SCN: Service Carrier network

A multi-domain centralized content-centric networking (MCCN) comprises a management layer, a control layer and a data layer. The management layer communicates with the data layer through the control layer. The management layer is configured to acquire application transmission requests, network resource allocation and network running status and give network operating commands to the control plane according to reconfiguration management strategies. The control layer carries out routing establishment, maintains the network topology of domains, informs the management layer of the network status, and executes the commands of the management layer. The data layer is configured to process the data packet according to the commands of the control layer. The task of the data layer is completed by the router and link of the bottom layer.

The working principle of the control layer is as follows: the Master is linked to the Controller of each domain directly through switch equipment; in the Master, every control and management domain is abstracted as a node and the Controller of each control and management domain sends the domain link information periodically to the Master; according to the domain information uploaded by each control server, the Master builds topological structures of all control and management domains so as to carry out the coarse-grained control of each domain; the control server of each control and management domain controls the node and link of the corresponding domain so as to carry out the fine-grained control of the domain; and the Controller collects the uploaded neighbor information and link information from routing nodes and builds an intra-domain topological graph to work out paths for intra-domain routing.

Every service carrier network of routers comprises a PIT and a FIB table in the router. The Interest packet records and forwards data according to the PIT and FIB of the service carrier network of the Interest packet.

The intra-domain communication of the multi-domain centralized content-centric networking (MCCN) comprises content registration, topological management and routing computation.

The specific content of the content registration is that: when content is sent to a router, the router verifies the content Data packet and if the Data packet is reliable, the Data packet is added to the content store and registration information is sent to the domain controller of the router; and the specific content of the topological management is that: all routers are linked to intra-domain controllers through switches, the communication between the intra-controllers and the routers adopts the signaling channel different from the Data packet communication, the router transmits heartbeat information to the controller in a unidirectional way and the intra-domain controller constantly updates the heartbeat information of the router; and the routing computation is that: the controller works out the best path to release the entries of the routing table according to the reconfigurable carrier network.

When carrying out the inter-domain communication, the multi-domain centralized content-centric networking (MCCN) sends the Interest packet to link routing paths through border routers; inter-domain paths are linked by a plurality of intra-domain paths; and the intra-domain controller just completes the task of the corresponding domain.

Controllers Release Paths

Routers decide whether the content of the received Data packet is the new content released by a content publisher for router cache and registration so that controllers can perform addressing or is the existing content forwarding between routers.

The invention takes full advantage of the easy management and control characteristic of centralized networks and the properties of the CCN networking, draws lesions from the control-forwarding separation thought, puts forward a new network architecture MCCN which features configurable network management and adopts hierarchical control support cross-domain, and provides a reliable routing protocol for MCCN by combining with the Named-data Link State Routing Protocol. The MCCN contains the easy expansion characteristic of distributed networks and the easy control characteristic of centralized networks.

Compared to the SDN, the network structure of the MCCN has the following differences:

1) The invention is a three-layer network and comprises a management layer, a control layer and a data layer. The management layer communicates with the data layer through the control layer.

2) The invention also uses the thought of control-forwarding separation but bottom-layer nodes are routers rather than switches and forward data by entries of the FIB table.

3) The invention is a network for content and name-addressable rather than a traditional IP-addressable network.

4) The invention is a cross-domain network structure and has a hierarchical control structure.

5) The invention is a network structure which can support the existence of service carrier network.

Compared to the NLSR, the routing protocol of the MCCN has the following differences:

1) The invention combines with control and forwarding separation and the router nodes only record information of entries of the FIB table related to data packets forwarded by the router nodes. The invention effectively reduces the expansion of the FIB table.

2) Every router node of the invention only needs to maintain the link status of the router which is directly linked to router node and does not need to synchronize with the link status of the whole network so as to reduce a great deal of bandwidth consumed by router link status synchronization.

3) The invention is a routing protocol which supports dynamic resource adjustments. The controllers cannot calculate paths from global topology but maps the global topology into service carrier networks. The invention improves the rate of path computation according by requesting the service carrier network of the Interest packet to compute the paths.

4) The path computation of the invention is all completed by controllers. The routers are only responsible for forwarding data and requesting forwarding table entries. The functions and duties are clearer.

5) The cross-domain communication of the invention needs a hierarchical control structure. The routing process sets up inter-domain paths first and then builds intra-domain paths by inter-domain paths. Then, border routers are used to link all intra-domain paths.

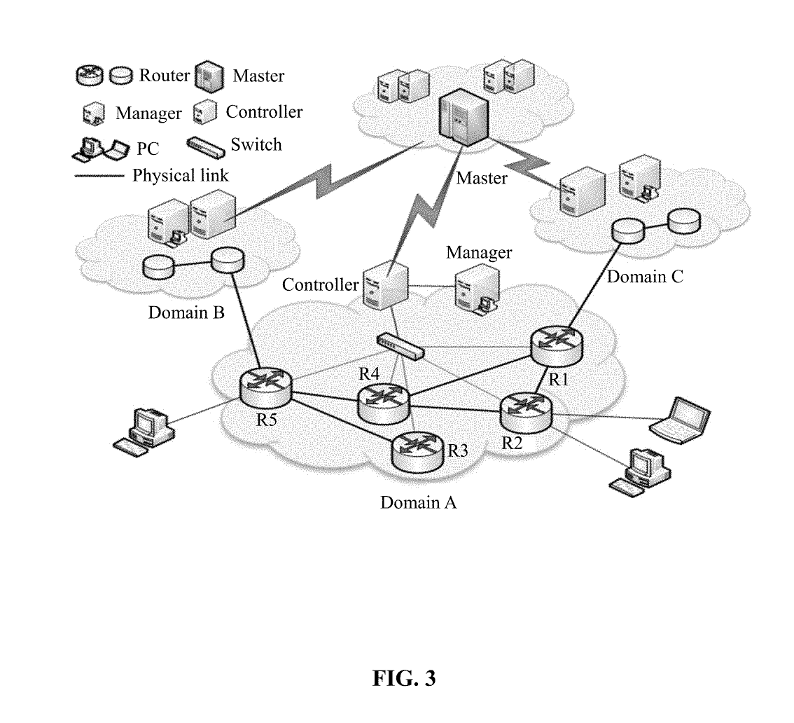

In one embodiment as shown in FIG. 3, the MCCN is a network system which is constituted by a plurality of control and management domains and can realize inter-domain communication. For example, for Domain A, every control and management domain of the MCCN is a three-layer structure and comprises a management layer, a control layer and a data layer. The task management server Manager is responsible for the task of the management layer. The control server Controller is responsible for the task of the control layer. The task of the data layer is completed by routers and links of the bottom layer.

The management layer comprises a series of functions such as configuration management, troubleshooting, troubleshooting, security control, accounting management and business carrier management. Cognition is an important function in the management plane, provides cognitive services of business and networks and collaborative services between nodes and networks for the business carrier management in the management plane and provides smart support for the generation of service carrier networks. As the center of the MCCN, the management layer is configured to acquire application transmission requests, network resource allocation and network running status and give network operating commands to the control plane according to reconfigurable management strategies. The management layer does not participate in data forwarding but is above the physical network.

The main task of the control layer is to be responsible for routing establishment, maintains intra-domain network topology, informs the management layer of network status and executes various measures and actions released by the management layer. The control layer is the actual controller of the service carrier network function and also the control center of various business requirement strategies like data security strategies. The control layer is the guarantee of data accessibility and cognition also lies in the control layer. Through cognition, the control layer can build reasonable data forwarding paths for the data layer. The control layer is the intermediate layer of the data layer and the management layer. The management layer and the data layer do not interact with each other. Therefore, the control layer is the communication bridge between the management layer and the data layer.

The transmission relation of the data layer and the data packet comprises a series of data-related modules such as data sending and receiving, data classification and packet processing units. The data layer can conduct corresponding treatment of data packets of specific identification according to the specific operations of the control layer so as to guarantee data stream transmission requirements.

The cross-domain structure of the MCCN is the subdivision of the control layer in essence and the structure where the control layer is realizing a plurality of layers. The Master as shown in FIG. 3 is the master control core of the MCCN and is directly linked to the Controller of each domain through switch equipment. In the Master, every control and management domain is abstracted as a node and the Controller of each control and management domain sends the domain link information periodically to the Master. According to the domain information uploaded by each control server, the Master builds topological structures of all control and management domains so as to carry out the coarse-grained control of each domain.

The control server of every control and management domain controls the nodes and links of the domain of the control server and is the fine-grained control of the domain of the control server. The Controller collects the uploaded neighbor information and link information from routing nodes and builds an intra-domain topological graph to work out paths for intra-domain routing.

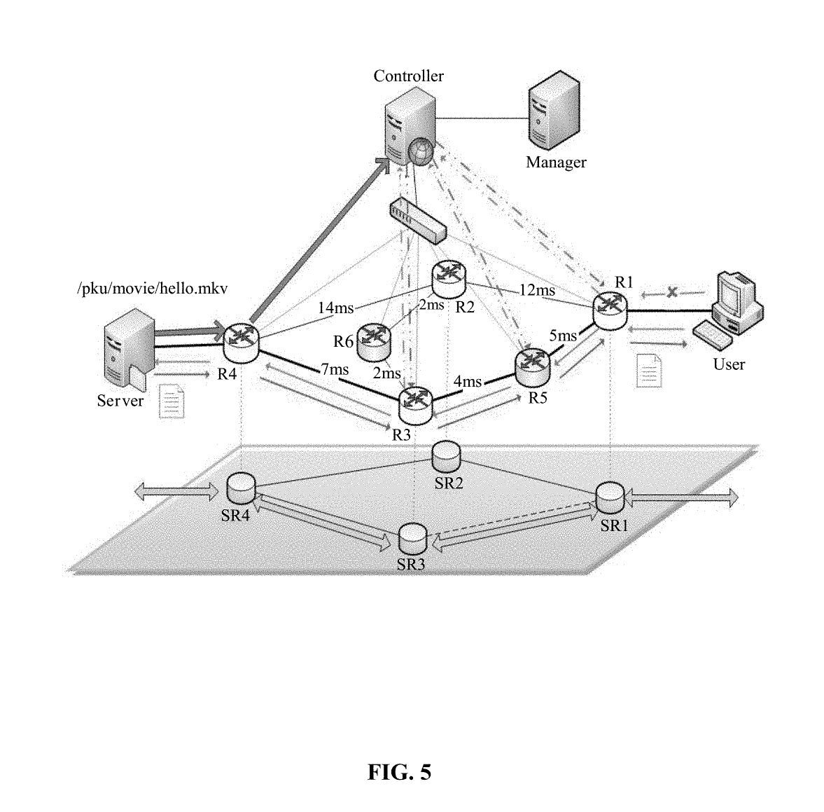

In order to make the MCCN support service carrier networks, complete routing addressing and provide specific data packet treatment services, we modify the original CCN data packet formats as shown in FIG. 5. We retain excellent design of the original CCN and, on this basis, add two fields to the Interest packet: carrier network and service fields. The carrier network field marks which service carrier network and service fields the Interest packet belongs to. In addition, a registration field Register is also added to the Data packet and used for routers to decide whether the content of the received Data packet is the new content released by a content publisher for router cache and registration so that controllers can perform addressing or is the existing content forwarding between routers.

In addition, due to the existence of service carrier networks, a router may belong to a plurality of service carrier networks. Therefore, every router is not just a PIT and a FIB table like original CCN nodes. Every service carrier network of routers in the MCCN has a PIT and a FIB table. The Interest packet records and forwards data according to the PIT and FIB table of the service carrier network of the Interest packet.

FIG. 5 shows the intra-domain communication process of the MCCN. The steps of content registration, topological management and routing computation need to be taken in order to complete the communication process of the MCCN.

Content Registration: all addressable content in the MCCN needs preregistration and then can be accessed by other network equipment. The content release server has the content named /pku/movie/hello.mkv which needs to be released to the router R4. The Server sends the Data packet named /pku/movie/hello.mkv to the R4 and the parameter of the Data packet is set as registration. The R4 receives the Data packet and verifies the integrity and security of the Data packet. If the Data packet is reliable, the Data packet is added to the content store, sends registration information to the Controller of the R4 and informs the Controller that the content named /pku/movie/hello.mkv can be obtained by the R4.

Topological Management: all routers shown in the figure are directly linked to the Controller through switches. The communication between the controllers and the routers adopts signaling channels different from the Data packet communication. The router transmits heartbeat information to the controller in a unidirectional way, and tells the controller about the router's neighbor, the average link delay with the neighbor and the routers' parameters such as the cache utilization rate, the packet loss rate and the CPU utilization rate. The Controller constantly updates the heartbeat information of the router. If a router does not transmit heartbeat information during the period of a plurality of heartbeats, it is deemed that the router disappears from the current network. The Controller deletes the router from the topology and sends warning formation to the management server Manager.

Routing Process: every MCCN has many reconfigurable service carrier networks. The reconfigurable service carrier networks either generate automatically according to network status or manually generate or are modified through the Manager. R1, R2, R3 and R4 as shown in the figure constitute a reconfigurable service carrier network which supports the service 1, correspond to SR1, SR2, SR3 and SR4 respectively in the reconfigurable service carrier network. Among them, the path between SR1 and SR3 is a virtual path. The User linking to R1 sends an Interest packet with the content of /pku/movie/hello.mkv obtained from the service 1. After R1 receives the Interest packet, R1 checks whether the Interest packet belongs to the service scope of R1 first. Since R1 is in the carrier network of the service 1 and the cache of R1 does not have the content of /pku/movie/hello.mkv, R1 starts to forward the Interest packet. Since the content of /pku/movie/hello.mkv has not been requested in R1, R1 does not know how to forward the Interest packet. Therefore, R1 requests a path from the controller. The controller works out the best path SR1-SR3-SR4 according to the reconfigurable carrier network of the service 1 and then sends routing table entries to SR1 and SR3 respectively. The controller tells SR1 to obtain the Interest packet with the content of /pku/movie/hello.mkv to send the Interest packet to SR3. The controller tells SR3 to obtain the Interest packet with the content of /pku/movie/hello.mkv to send the Interest packet to SR4. When SR1 forwards the Interest packet, SR1 finds that SR3 is not SR1's real neighbor. Therefore, SR1 requests the physical path between SR1 and SR3 again from the controller. The controller modifies the entrance of SR1 into R5, adds the obtained Interest packet with the content of /pku/movie/hello.mkv to the overall FIB tale of the controller and sends the Interest packet to R3. Then, the communication between the virtual path and the actual path in the reconfigurable service carrier network is completed. After SR4 receives the Interest packet, SR4 encapsulates the content in the content packet named /pku/movie/hello.mkv and the content backtracks to users according to the transmission path of the Interest packet. If the content of /pku/movie/hello.mkv is larger, the content packet is sent segment by segment and the transmission time is related to the bandwidth. The network link status changes when the transmission time is longer. Once the router finds a jam, a new path is worked out for transmission. As shown in the figure, if the R3-R4 path is jammed, R3 tells the Controller about the jam. The Controller works out the better R1-R2-R4 path and then leads the data to pass the new links.

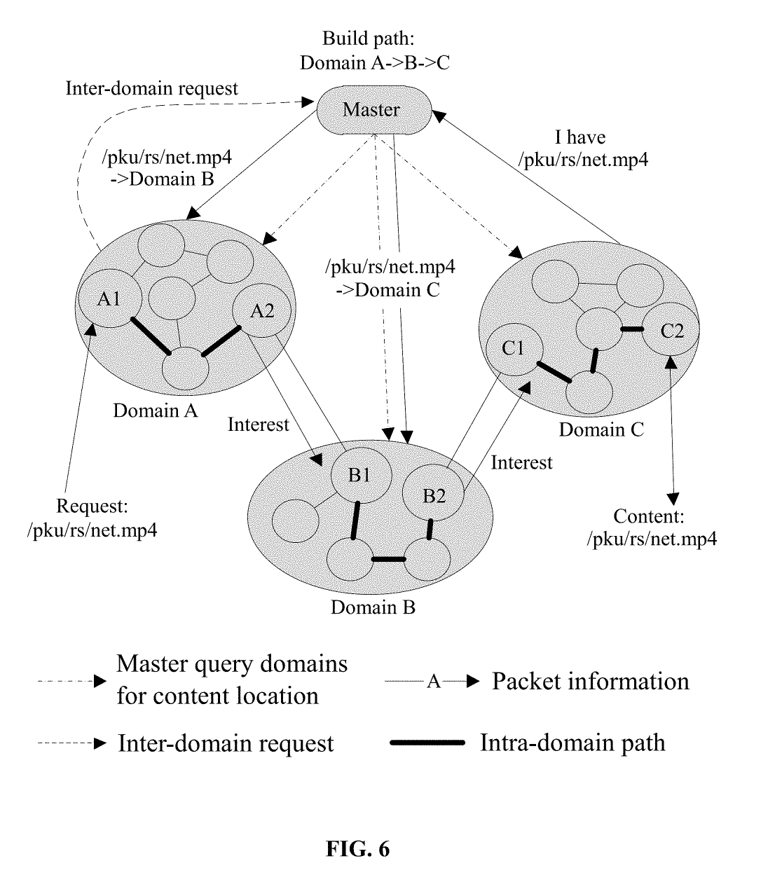

FIG. 6 shows the inter-domain routing communication process.

When a request is made to the A1 router of the Domain A for the content named “/pku/rs/net.mp4”, the Controller of the Domain A finds that the content is not in the control and management domain of the Domain A and then sends an inter-domain request to the Master.

The Master broadcasts inquiry requests to all control and management domains to request the content of /pku/rs/net.mp4.

If Domain C has the content, Domain C tells the Master that Domain C has “/pku/rs/net.mp4”.

Then, the Master works out a path Domain A->B->C according to the topology of the control and management domain and then sends the path routing information to Domain A and Domain B of the path.

After Domain A and Domain B receive the path architecture information of the Master, Domain A and Domain B builds a path between the source node and the border router according to the information, for example, the A1-A2 path and the B1-B2 path. At the moment, the path is not continuous and cannot complete cross-domain actions.

At the moment, the border router A2 sends an Interest request content “/pku/rs/net.mp4” to B1 of Domain B. B2 sends an Interest request content “/pku/rs/net.mp4” to C1.

The border router C1 of Domain C guides accounting to work out a C1-C2 path according to the intra-domain Control and then the content can return to A1 from C2. Therefore, the inter-domain communication process is realized.

According to business requirements, the invention divides service carrier networks, and can take good advantage of bottom-layer resources better. The invention releases paths by controllers, avoids transmission of a large quantity of Interest packets caused by flooding and effectively improves link utilization rate. The inter-domain communication allows the MCCN to realize large-scale arrangements. The abstract domain topology of the Master effectively reduces the quantity of nodes and the routing computation time and speeds up the communication speed. The inter-domain paths are linked by a plurality of intra-domain paths. The intra-domain controller still only needs to focus on intra-domain work. Clear responsibilities reduce the burden. Different service carrier networks all have a PIT and a FIB table, avoids expansion of PITs and FIB tables and speed up the inquiry rate.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A multi-domain centralized content-centric networking (MCCN), comprising:
a management layer;
a control layer; and
a data layer;
wherein
the management layer communicates with the data layer through the control layer;
the management layer is configured to acquire application transmission requests, network resource allocation, and network running status, and give network operating commands to a control plane according to reconfiguration of management strategies;
the control layer is configured to carry out routing establishment, maintain network topology of domains, inform the management layer of network status, and execute commands of the management layer; and
the data layer is configured to process data packet according to commands of the control layer; a task of the data layer is completed by a router and link of a bottom layer.

2. The MCCN of claim 1, wherein a working principle of the control layer is as follows: a Master is linked to a Controller of each domain directly through switch equipment; in the Master, every control and management domain is abstracted as a node and the Controller of each control and management domain sends domain link information periodically to the Master; according to the domain information uploaded by each control server, the Master builds topological structures of all control and management domains so as to carry out the coarse-grained control of each domain; a control server of each control and management domain controls a node and link of the corresponding domain so as to carry out the fine-grained control of the domain; and the Controller collects uploaded neighbor information and link information from routing nodes and builds an intra-domain topological graph to work out paths for intra-domain routing.

3. The MCCN of claim 1, wherein every service carrier network of routers comprises a PIT and a FIB table in the router; an Interest packet records and forwards data, according to the PIT and FIB of the service carrier network of the Interest packet.

4. The MCCN of claim 1, wherein the intra-domain communication of the content-based centralized routing architecture MCCN comprises content registration, topological management and routing computation.

5. The MCCN of claim 4, wherein specific content of a content registration is that:
when content is sent to a router, the router verifies the content data packet and if the data packet is reliable, the data packet is added to a content store and registration information is sent to the domain controller of the router; and the specific content of the topological management is that: all routers are linked to intra-domain controllers through switches, the communication between an intra-controllers and the routers adopts a signaling channel different from the data packet communication, the router transmits heartbeat information to the controller in a unidirectional way and the intra-domain controller constantly updates the heartbeat information of the router; and the routing computation is that: the controller works out a best path to release the entries of the routing table according to the reconfigurable carrier network.

6. The MCCN of claim 1, wherein when carrying out an inter-domain communication, the MCCN sends an Interest packet to link routing paths through border routers; inter-domain paths are linked by a plurality of intra-domain paths;
and the intra-domain controller just completes the task of the corresponding domain. The MCCN of claim 2, wherein controllers release paths.

8. The MCCN of claim 2, wherein routers decide whether the content of the received Data packet is the new content released by a content publisher for router cache and registration so that controllers can perform addressing or is the existing content forwarding between routers.
